(19) United States
(12) Patent Application Publication
(10) Pub. No.: US 2018/0054818 A1
(43) Pub. Date: Feb. 22, 2018

(54) TECHNIQUES FOR COMMUNICATION MANAGEMENT USING MULTIPLE NETWORK ALLOCATION VECTORS

(71) Applicant: QUALCOMM Incorporated, San Diego, CA (US)

(72) Inventors: Naveen Kumar KAKANI, Coppell, TX (US); Alireza RAISSINIA, Monte Sereno, CA (US)

(21) Appl. No.: 15/674,272

(22) Filed: Aug. 10, 2017

Related U.S. Application Data
(60) Provisional application No. 62/377,368, filed on Aug. 19, 2016.

(51) Int. Cl. H04W 72/04; H04L 5/00

(52) U.S. Cl. CPC H04W 72/0446; H04W 88/08; H04L 5/0053

(57) ABSTRACT

Aspects of the present disclosure allow for one or more network allocation vectors (NAVs) to control whether or not the STA may transmit on the wireless channel depending on whether the NAV was set by a device in the same BSS (“intra-BSS”) or from a different BSS (OBSS or “inter-BSS”). In one aspect, the STA may maintain two NAVs (intra-BSS NAV and inter-BSS NAV). In accordance with one technique, if the inter-BSS NAV was previously set based on an in-deterministic frame (e.g., a frame received by the STA that cannot readily be identified as either intra-BSS frame or an inter-BSS frame), then the STA may respond to a trigger frame from an AP after the inter-BSS NAV has been set as though the inter-BSS NAV is intra-BSS NAV.

### CROSS-REFERENCE TO RELATED APPLICATION(S)

This application claims benefit of U.S. Provisional Application Ser. No. 62/377,368, entitled “TECHNIQUES FOR COMMUNICATION MANAGEMENT USING MULTIPLE NETWORK ALLOCATION VECTORS” and filed Aug. 19, 2016, which is expressly incorporated by reference herein in its entirety.

### BACKGROUND OF THE DISCLOSURE

The present disclosure relates generally to telecommunications, and specifically to techniques for spatial reuse implemented using a plurality of network allocation vectors (NAVs).

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. In some examples, a set of STAs can communicate with each other through a common AP in what is referred to as a basic service set (BSS). However, when two or more unrelated BSSs are close enough to hear each other and are operating in the same frequency (e.g., in a multi-dwelling setting where there may be multiple APs in a close proximity to one another), the transmissions by AP and STAs in one BSS may affect the AP and STAs in another BSS. Thus, in some examples, nearby BSSs may have overlapping coverage areas and such BSSs may be referred to as overlapping BSSs or OBSSs.

Some WLAN network deployments may be dense (e.g., have a large number of STAs deployed within the coverage area of multiple APs), which may result in issues related to channel or medium usage. Due to collisions and interference among STAs caused by the overlapping BSSs, channel resources may be unnecessarily wasted. For instance, in some examples, one or more STAs may receive packet(s) from an OBSS that are intended for a different STA in a different BSS. In this case, traffic from the OBSS may trigger a STA in a different BSS to initiate backoff procedures unnecessarily. For example, in order to minimize resource contentions between STAs, WLAN may require STAs to implement carrier sense multiple access (CSMA) techniques in which the STA may sense the channel and transmit only when it senses that the channel is idle (e.g., when the STA does not detect any IEEE 802.11 signals on the wireless channel from another AP or STA). In contrast, when a first STA hears the second STA (e.g., detects signals on the wireless channel from the second STA), it may be required to wait for a random amount of time for the second STA to stop transmitting before listening again for the channel to be free. Such techniques may be beneficial to avoid multiple STAs from the same BSS from attempting to transmit over the same wireless channel at the same time, and thus resulting in a condition where neither STA may be able to transmit.

In an alternative method to physical carrier-sensing, STAs may also utilize network allocation vector (NAV) which is a virtual carrier-sensing mechanism used with wireless network protocols such as IEEE 802.11. In some implementations, media access control (MAC) layer frame headers may contain a duration field that may specify the transmission time required for the frame, in which time the medium will be busy. Thus, a STA listening on the wireless medium may detect a frame transmitted by another STA or AP, and decode the MAC layer frame header of the frame to read the duration field in order to set its NAV, which is an indicator for a STA on how long it must defer from accessing the medium. In some aspects, the NAV may be thought of as a counter, which counts down to zero at a uniform rate. When the counter is zero, the virtual carrier sense indication is that the medium is idle. In contrast, when the counter has a nonzero value, the carrier sense indication is that the medium is busy.

However, in the instance where a first STA detects signals or frames on the wireless channel from a second STA that is not part of the same BSS as the first STA, initiating the backoff procedures or setting its NAV in accordance with the duration identified in the OBSS frame may unnecessarily prevent the first STA from transmitting on the wireless channel for a predetermined time period. Such delays in scheduling traffic transmission may result in reduced throughput rates experienced by the first STA.

### SUMMARY

Aspects of the present disclosure solve the above-identified problem by implementing techniques to increase reuse of the frequency channel by more than one device (e.g., spatial reuse). In one or more examples, aspects of the present disclosure allow for one or more network allocation vectors (NAVs) to control whether or not the STA may transmit on the wireless channel depending on whether the NAV was set by a device in the same BSS (“intra-BSS”) or from a different BSS (OBSS or “inter-BSS”). In one aspect, the STA may maintain two NAVs (intra-BSS NAV and inter-BSS NAV). In accordance with one technique, if the inter-BSS NAV was previously set based on an in-deterministic frame (e.g., a frame received by the STA that cannot readily be identified as either intra-BSS frame or an inter-BSS frame), then the STA may respond to a trigger frame from its AP after the inter-BSS NAV has been set as though the inter-BSS NAV is intra-BSS NAV. In contrast to the “in-deterministic frame,” a “deterministic-frame” may be a frame that is capable of being identified as either an intra-BSS frame or an inter-BSS frame based on BBSID included as part of the frame, or one of the address field is not matching the BSSID (or BSSIDs) of the AP with which the STA is associated with.

Additionally or alternatively, another technique may include setting the intra-BSS NAV (in contrast to inter-BSS NAV) in response to receiving an in-deterministic frame. Thereafter, if the STA receives a contention free-end (CF-END) frame from an intra-BSS frame, the STA may reset only the intra-BSS NAV in response to the CF-END frame being from an intra-BSS frame. In contrast, if the STA receives the CF-END frame from an inter-BSS frame, the STA may reset only the inter-BSS NAV, while maintaining the intra-BSS NAV, in response to the CF-END frame being from an inter-BSS frame.

In some examples, a method for wireless communication is disclosed. The method may include determining, at a wireless STA, that a frame received by the STA cannot be identified as an intra-BSS frame or an inter-BSS frame. The method may further include setting a first NAV in response to the determination. The first NAV may be associated with intra-BSS transmissions. The method may further include receiving a CF-END message from an intra-BSS frame or an inter-BSS frame, and resetting the first NAV in response to the CF-END message being from an intra-BSS frame or a second NAV in response to the CF-END message being from an inter-BSS frame. The second NAV may be associated with the inter-BSS transmission.

In another example, an apparatus for wireless communication is disclosed. The apparatus may include a processor and a memory coupled to the processor. The memory may include instructions executable by the processor to determine, at a wireless STA, that a frame received by the STA cannot be identified as an intra-BSS frame or an inter-BSS frame. The instructions may further be executable by the processor to set a first NAV in response to the determination. The first NAV may be associated with intra-BSS transmission. The instructions may further be executable by the processor to receive a CF-END message from an intra-BSS frame or an inter-BSS frame. The instructions may further be executable by the processor to reset the first NAV in response to the CF-END message being from an intra-BSS frame or a second NAV in response to the CF-END message being from an inter-BSS frame. The second NAV may be associated with inter-BSS transmission.

In another example, a computer-readable medium storing computer executable code for wireless communications is disclosed. The computer-readable medium may include code to determine, at a wireless STA, that a frame received by the STA cannot be identified as an intra-BSS frame or an inter-BSS frame. The computer-readable medium may further include code to set a first NAV in response to the determination. The first NAV may be associated with intra-BSS transmissions. The computer-readable medium may further include code to receive a CF-END message from an intra-BSS frame or an inter-BSS frame, and resetting the first NAV in response to the CF-END message being from an intra-BSS frame or a second NAV in response to the CF-END message being from an inter-BSS frame. The second NAV may be associated with the inter-BSS transmission.

In another example, an apparatus for wireless communication is disclosed. The apparatus may include means for determining, at a wireless STA, that a frame received by the STA cannot be identified as an intra-BSS frame or an inter-BSS frame. The apparatus may further include means for setting a first NAV in response to the determination. The first NAV may be associated with intra-BSS transmissions. The apparatus may further include means for receiving a CF-END message from an intra-BSS frame or an inter-BSS frame, and resetting the first NAV in response to the CF-END message being from an intra-BSS frame or a second NAV in response to the CF-END message being from an inter-BSS frame. The second NAV may be associated with the inter-BSS transmission.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a conceptual diagram illustrating an example of a wireless local area network (WLAN) deployment;

FIGS. 2A-2B is a timing diagram of one example of techniques for improving spatial reuse in accordance with aspects of the present disclosure;

FIG. 3 is another timing diagram of another example of techniques for improving spatial reuse in accordance with aspects of the present disclosure;

FIG. 4 illustrates one example of a flowchart that shows aspects for reducing delay in traffic transmission in an OBSS environment in accordance with various aspects of the present disclosure;

FIG. 5 illustrates another example of a flowchart that shows aspects for reducing delay in traffic transmission in an OBSS environment, while minimizing interference in BSS region in accordance with various aspects of the present disclosure; and

FIG. 6 is a schematic diagram of a device including an aspect of an STA that may implement various aspects of the present disclosure.

### DETAILED DESCRIPTION

As discussed above, some WLAN network deployments may be dense (e.g., have a large number of STAs deployed within the coverage area of multiple APs), which may result in issues related to channel or medium usage. In order to minimize interference or resource contentions, IEEE 802.11 protocol dictates that STAs use a carrier sense multiple access (CSMA) method in which the STA first senses the wireless channel (e.g., monitor or detect activity on the wireless channel) and attempt to avoid collisions by transmitting only when they sense the channel to be idle (e.g., when STA does not detect any 802.11 signals on the channel). In contrast, when an STA detects a signal from a different STA, it may assume that the detected signal is from the same BSS, and thus wait for a predetermined amount of time before listening again for the channel to be free.

WLAN STAs may also use Request to Send/Clear to Send (RTS/CTS) signals to mediate access to the shared medium. In such situations, the AP may issue a CTS packet to one STA at a time, which in turn sends its entire frame to the AP. The STA then waits for an acknowledgement (ACK) packet from the AP indicating that the AP received the packet correctly. If the STA does not receive the ACK in time the STA presumes the packet collided with some other transmission, and thus moves the STA to execute backoff operations. The term “backoff operation” may refer to the process of waiting a designated time interval or time period before the STA or AP may attempt accessing a channel or medium. The term “backoff operation” may also be associated with techniques used to space out retransmissions over time as part of network congestion avoidance. An example of such techniques is the exponential backoff algorithm in which a random value within an acceptable range is selected to schedule retransmissions after collisions to avoid further collisions from taking place. Returning to the above example, the STA, after failing to receive an ACK and entering a backoff operation, may try to access the medium and re-transmit its packet again after the backoff counter expires.

As discussed above, an alternative method to physical carrier-sensing may include reliance on a network allocation vector (NAV), which is a virtual carrier-sensing mechanism used with wireless network protocols such as IEEE 802.11. In some implementations, media access control (MAC) layer frame headers may contain a duration field that may specify the transmission time required for the frame, in which time the medium will be busy. Thus, a STA listening on the wireless medium may detect a frame transmitted by another STA or AP, and decode the MAC layer frame header of the frame to read the duration field in order to set its NAV, which is an indicator for a STA on how long it must defer from accessing the medium. In some aspects, the NAV may be thought of as a counter, which counts down to zero at a uniform rate. When the counter is zero, the virtual carrier sense indication is that the medium is idle. In contrast, when the counter has a nonzero value, the carrier sense indication is that the medium is busy.

Although the Clear Channel Assessment (CCA) and Collision Avoidance (CA) protocols serves well to divide the channel relatively equally among all participants within the collision domain, its efficiency decreases when the number of participants grows very large. In some examples, a factor that contributes to network inefficiency may include having a plurality of APs with overlapping areas of service. Thus, as discussed above, in the instance where the first STA detects signals on the wireless channel from a second STA that is not part of the same BSS as the first STA, initiating the backoff procedures or setting the NAVs based on OBSS frames prevents the first STA from transmitting on the wireless channel for a predetermined time period. This prevents the medium to be used inadvertently by the first STA and effect the transmissions on the air by the second STA. However, if the second STA now completes its transmission and it sends a CF-END, the first STA can start using the medium, and it can affect any ongoing transmission in its own BSS (transmissions to the AP from a hidden node). Also, the first STA will not be able to use the medium even if there is medium allocation in a Trigger frame by its own AP, because it senses the medium to be busy.

To improve the system level performance and the efficient use of spectrum resources in dense deployment scenarios, the IEEE 802.11ax standard implements a spatial reuse technique. Particularly, the IEEE 802.11ax standard indicates that the STA should have a mechanism to remember and distinguish NAVs set by intra-BSS frame and OBSS frame. In some examples, in order to determine which BSS is the origin of the frame, the standard proposes the use of BSS color. In some examples, BSS color may refer to the BSS identification (ID) associated with each BSS.

Thus, STAs can identify signals or frames from OBSS and make appropriate decisions on medium contention and interference management based on this information. For example, when an STA that is actively listening to the medium detects an IEEE 802.11ax frame, the STA checks the BSS color bit or MAC address in the MAC header. If the BSS color in the detected frame is the same color as the one that the STA's associated AP has already announced, then the STA considers that frame as an intra-BSS frame and sets its intra-BSS NAV. However, if the detected frame has a different BSS color than its own, then the STA considers that frame as an inter-BSS frame from an overlapping BSS and sets its inter-BSS NAV.

However, in some situations, it may be difficult to determine whether a detected frame is an intra-BSS frame or an inter-BSS frame due to the lack of BSS color or MAC address associated with the frame. For example, CTS frames or acknowledgment (ACK) frames that are transmitted in response to the RTS frame or data frame respectively, do not generally include BSS information. In such situations, generally the STA does not know whether to set intra-BSS NAV or inter-BSS NAV. In order to resolve the above problem, some systems propose setting the inter-BSS NAV in response to receiving or detecting an in-deterministic frames. However, setting the inter-BSS NAV in response to an in-deterministic frame may result in two issues.

First, if, the STA receives a trigger frame from an AP (same BSS as the STA) while the inter-BSS NAV is set, the STA is limited in what it can transmit on the wireless medium if the STA is allocated resources in the trigger fame, also until the inter-BSS NAV counter reaches zero or the STA receives a CF-END frame from an inter-BSS STA the STA cannot access the medium to transmit its data by regular EDCA. Second, because only the inter-BSS NAV was set (and not intra-BSS NAV) based on the in-deterministic frame, if the STA subsequently receives a CF-END from an inter-BSS STA, the STA would be free to access the medium and potentially collide with an intra-BSS transmissions (e.g., another STA communicating with the AP). Thus, such implementations of setting an inter-BSS NAV in response to receiving an in-deterministic frames limits the STA from responding to trigger frames from the AP and/or may cause interference with communications within its own BSS.

Aspects of the present disclosure solve the above-identified problems by implementing techniques to increase reuse of the frequency channel by more than one device (e.g., spatial reuse). In accordance with one technique, if the STA receives a trigger frame from an AP after an inter-BSS NAV has been set, the STA may determine whether the inter-BSS NAV was previously set based on an in-deterministic frame (e.g., a frame received by the STA that cannot readily be identified as either intra-BSS frame or an inter-BSS frame). If the inter-BSS NAV was set in response to an in-deterministic frame, aspects of the present disclosure allow for the STA to transmit, in response to receiving the trigger frame and before the inter-BSS NAV is reset, a response to the trigger frame by operating the inter-NAV as an intra-NAV associated with intra-BSS transmissions. Particularly, because trigger frames include resource allocations from the AP that identify the time slots and frequency the STA is to utilize in communicating with the AP for its response, the potential for causing interference on its own BSS is severely minimized. Such an implementation also solves the first problem identified above by not limiting the STA from responding to trigger frames from its own BSS.

Another technique may include setting the intra-BSS NAV (in contrast to inter-BSS NAV) in response to receiving an in-deterministic frame. Thereafter, if the STA receives a CF-END frame from an intra-BSS frame, the STA may reset only the intra-BSS NAV in response to the CF-END frame being from an intra-BSS frame. In contrast, if the STA receives the CF-END frame from an inter-BSS frame, the STA may reset only the inter-BSS NAV (while maintaining the inter-BSS NAV), in response to the CF-END frame being from an inter-BSS frame. Thus, in such situations, the STA may be prevented from accessing the wireless medium and causing interference on its own BSS until such time that the STA receives a CF-END frame from an intra-BSS STA.

Various concepts will now be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details. However, it will be apparent to those skilled in the art that these concepts may be practiced without these specific details. In some instances, well known structures and components are shown in block diagram form in order to avoid obscuring the various concepts presented throughout this disclosure.

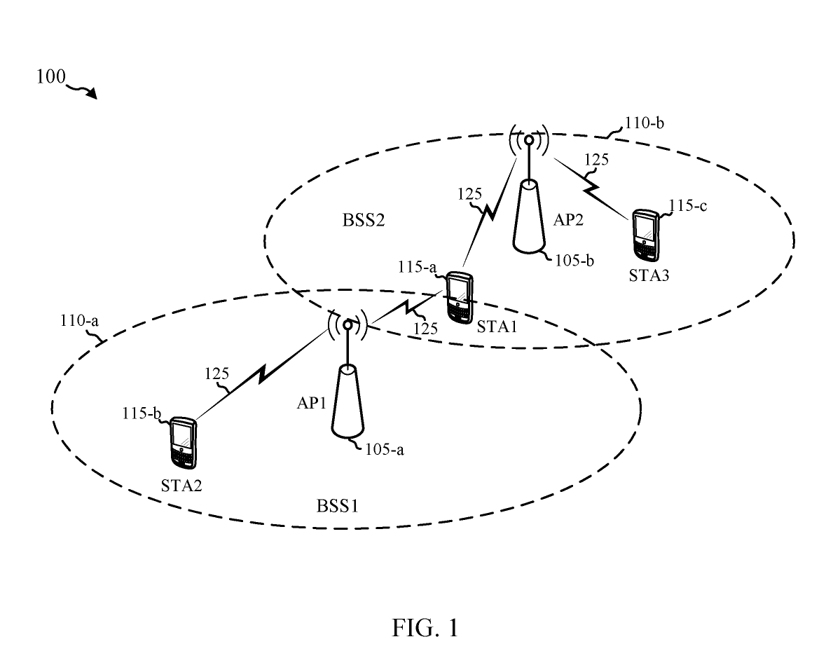

FIG. 1 is a conceptual diagram 100 illustrating an example of a wireless local area network (WLAN) deployment in connection with various techniques described herein. The WLAN may include one or more access points (APs) and one or more mobile stations (STAs) associated with a respective AP. In this example, there are two APs deployed: AP1 105-a in basic service set 1 (BSS1) and AP2 105-b in BSS2, which may be referred to as an OBSS. AP1 105-a is shown as having at least two associated STAs (STA1 115-a and STA2 115-b) and coverage area 110-a, while AP2 105-b is shown having at least two associated STAs (STA1 115-a and STA3 115-c) and coverage area 110-b. The STAs and AP associated with a particular BSS may be referred to as members of that BSS. In the example of FIG. 1, the coverage area of API 105-a may overlap part of the coverage area of AP2 105-b such that STA1 115-a may be within the overlapping portion of the coverage areas. The number of BSSs, APs, and STAs, and the coverage areas of the APs described in connection with the WLAN deployment of FIG. 1 are provided by way of illustration and not of limitation.

In some examples, the APs (e.g., AP1 105-a and AP2 105-b) shown in FIG. 1 are generally fixed terminals that provide backhaul services to STAs 115 within its coverage area or region. In some applications, however, the AP may be a mobile or non-fixed terminal. The STAs (e.g., STA1 115-a, STA2 115-b and STA3 115-c) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to all suitable wireless apparatus regardless of their specific nomenclature.

Each of STA1 115-a, STA2 115-b, and STA3 115-c may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications link 125. The APs can send frames or packets to their respective STAs and receive frames or packets from their respective STAs to communicate data and/or control information (e.g., signaling). Each of AP1 105-a and AP2 105-b can establish a communications link 125 with an STA that is within the coverage area of the AP. Communications link 125 can comprise communications channels that can enable both uplink and downlink communications. When connecting to an AP, an STA can first authenticate itself with the AP and then associate itself with the AP. Once associated, a communications link 125 may be established between the AP 105 and the STA 115 such that the AP 105 and the associated STA 115 may exchange frames or messages through a direct communications channel. It should be noted that the wireless communication system, in some examples, may not have a central AP (e.g., AP 105), but rather may function as a peer-to-peer network between the STAs. Accordingly, the functions of the AP 105 described herein may alternatively be performed by one or more of the STAs 115.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for performing operations based on modifications and enhancements to dynamic sensitivity control may be applicable to any suitable wireless network regardless of the coverage range and the wireless access protocols utilized.

In some aspects, one or more APs (105-a and 105-b) may transmit on one or more channels (e.g., multiple narrowband channels, each channel including a frequency bandwidth) a beacon signal (or simply a “beacon”), via a communications link 125 to STA(s) 115 of the wireless communication system, which may help the STA(s) 115 to synchronize their timing with the APs 105, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a super-frame duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, wireless devices (e.g., STA 115 and/or AP 105) may, in order to increase reuse of the spectrum, transmit on top of transmissions coming from an OBSS and refrain from transmitting on top of transmissions coming from the same BSS (also known as in-BSS). To enable a wireless device to determine whether a transmission is from the same BSS as the wireless device or from an OBSS, some packets may have a color code/information that identifies the BSS from which the packets originated, in some cases the BSSID field is also included along with BSS color. Color code/information may be a BSS identifier (BSSID) or a partial BSSID or separate value advertised by the AP. When the wireless device receives a packet with color information, the wireless device may determine if the packet is associated with the same BSS as the wireless device, and may therefore defer transmissions, or if the packet is associated with an OBSS, in which case the wireless device may reuse the spectrum.

However, in some situations, it may be difficult to determine whether a detected frame is an intra-BSS frame (e.g., transmitted from BSS1) or an inter-BSS frame (e.g., transmitted from BSS2) due to the lack of BSS color or MAC address associated (BSSID) with the frame. Examples of in-deterministic frames may include, but are not limited to CTS frames or ACK frames.

In accordance with one technique, the STA1 115-a sets an inter-BSS NAV in response to receiving an in-deterministic frame. Subsequently, if the STA1 115-a receives a trigger frame from an AP after an inter-BSS NAV has been set, the STA1 115-a may determine whether the inter-BSS NAV was previously set based on an in-deterministic frame. If the inter-BSS NAV was set in response to an in-deterministic frame, aspects of the present disclosure allow for the STA1 115-a to transmit, in response to receiving the trigger frame and before the inter-BSS NAV is reset, a response to the trigger frame by operating the inter-BSS NAV as an intra-BSS NAV associated with intra-BSS transmissions. Particularly, because trigger frames include resource allocations from the AP 105-a that identify the duration and frequency the STA1 115-a is to utilize in communicating with the AP 105-a for its response, the potential for causing interference on its own BSS (e.g., in BSS1) is minimized.

In accordance with another technique, the STA1 115-a may set the intra-BSS NAV (in contrast to inter-BSS NAV) in response to receiving an in-deterministic frame. Thereafter, if the STA1 115-a receives a CF-END frame from an intra-BSS device (e.g., STA2 115-b or AP 105-a in BSS1), the STA1 115-a may reset only the intra-BSS NAV in response to the CF-END frame being from an intra-BSS frame. In contrast, if the STA receives the CF-END frame from an inter-BSS device (e.g., STA3 115-c or AP 105-b in BSS2), the STA1 115-a may reset only the inter-BSS NAV (while maintaining the inter-BSS NAV), in response to the CF-END frame being from an inter-BSS frame. Thus, in such situations, the STA1 115-a may be prevented from accessing the wireless medium and causing interference on its own BSS until such time that the STA1 115-a receives a CF-END frame from an intra-BSS STA (e.g., STA2 115-b).

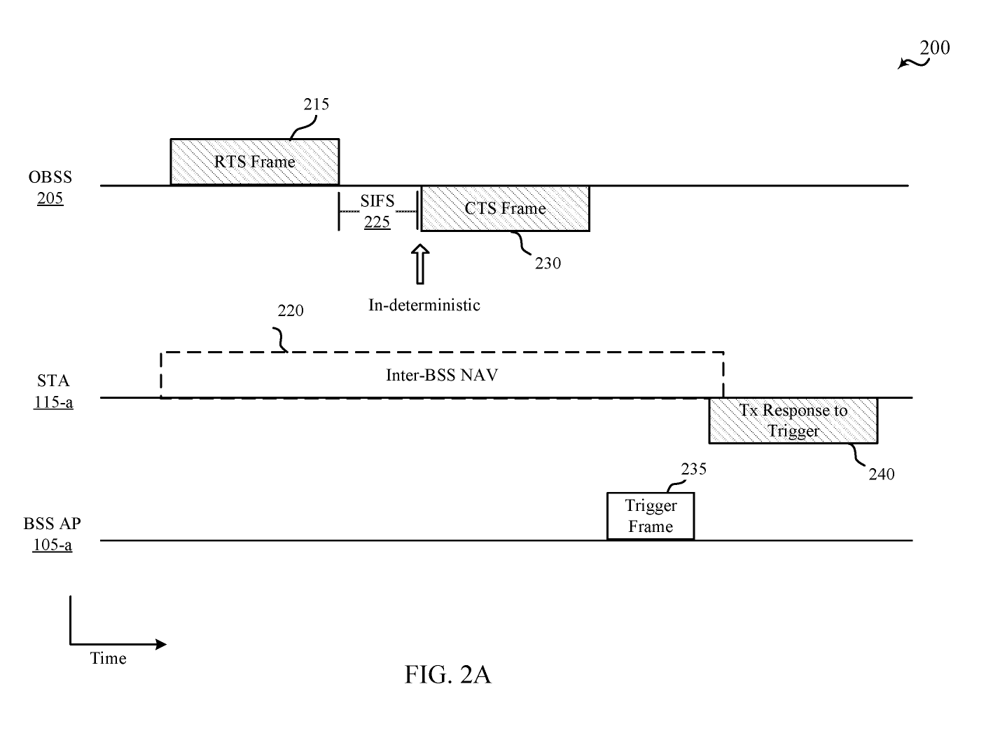

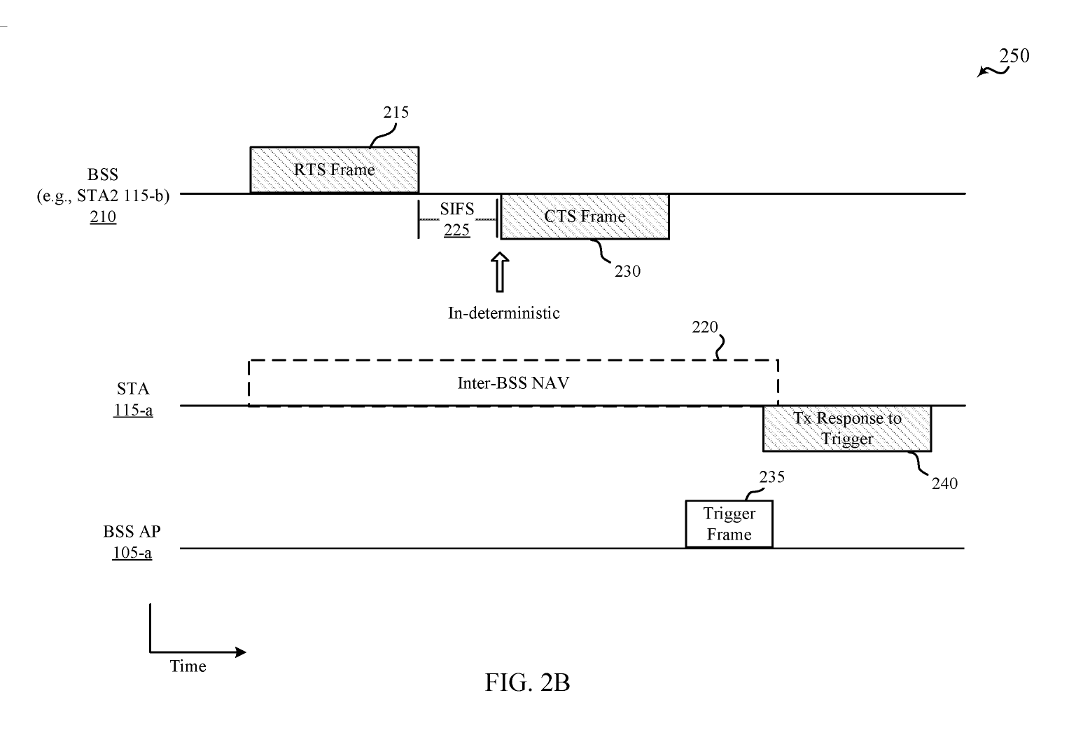

FIGS. 2A and 2B are a timing diagrams 200 and 250 associated with managing inter-BSS NAV and intra-BSS NAV based on reception of one or more frames on the shared wireless channel. The timing diagram 200 illustrates an OBSS device 205 that may be an AP or STA as illustrated in FIG. 1. In one example, the OBSS device 205 may be an AP 105-b and/or STA3 115-c belonging to or being a member of BSS2 described with reference to FIG. 1. Additionally or alternatively, the timing diagram 200 may include a BSS AP 105-a (e.g., in-BSS) that may be an example of AP 105-a illustrated in FIG. 1 as being a member of BSS1. In some examples, each of the OBSS device 205, STA 115-a and BSS AP 105-a may be configured to communicate over the shared wireless channel such that a transmission of a nearby STA or AP may be overheard by another STA.

In some aspects, an OBSS device 205 that may be in relatively close proximity to the STA 115-a may transmit a first frame 215 (e.g., RTS frame). Due to the proximity of the STA 115-a to the OBSS device 205, the STA 115-a may also receive (or detect) the first frame 215 on the wireless channel, even though the STA 115-a may not be the intended recipient of the first RTS frame 215. In some aspects, the STA 115-a, upon detecting the first frame 215, may decode portions of the MAC layer frame headers of the first frame 215 to identify a duration field that may specify the transmission time required for the first frame 215 (e.g., based on the size of the packet, the duration field may identify the time the medium may be busy). Because the first frame 215 (e.g., RTS frame or data packet) may include BSS color information in the packet, the STA 115-a may also be able to determine that the received first frame 215 is an OBSS frame. Accordingly, in some aspects, the STA 115-a may set its inter-BSS NAV 220-a based on the information derived from the duration field of the first frame 215. As noted above, the inter-BSS NAV 220-a may be a counter, which counts down to zero at a uniform rate. When the counter is zero, the virtual carrier sense indication is that the medium is idle. In contrast, when the counter has a nonzero value, the carrier sense indication is that the medium is busy. Thus, while the inter-BSS NAV 220-a is non-zero value, the STA 115-a may be prevented from transmitting on the wireless medium.

As noted earlier, WLAN STAs use RTS/CTS frames to mediate access to the shared medium. Thus, an RTS frame 215 may generally correspond with a CTS frame 230 being transmitted by the intended recipient of the RTS frame 215. In some examples, the period of time between RTS frame 215 and the CTS frame 230 may be based on the short interframe space (SIFS) 225. In contrast to RTS frame 215, a CTS frame 230 does not include BSS color information. As such, CTS frame 230 (and ACK frames) are considered to be “in-deterministic” frames because such frames cannot be identified as an intra-BSS frame or an inter-BSS frame based on decoding the frame itself.

In some examples, aspects of the present disclosure may attempt to infer whether the in-deterministic frame (e.g., CTS frame 230) is an intra-BSS frame or an inter-BSS frame based on the characteristics of a preceding frame (e.g., RTS frame 215) detected before the receipt of the in-deterministic frame. In some examples, the STA 115-a may determine whether the frame is received at the STA within a threshold period of time (e.g., within SIFS period 225) since detecting a preceding frame 215 (e.g., RTS frame or data frame) that included BSS color information, BSSID field, there is a match between the address fields in RTS/Data frames and the frame received. As such, in some aspects, the STA 115-a may be configured to identify the in-deterministic frame as the intra-BSS frame or the inter-BSS frame based on determining whether the frame is received within the threshold period of time since detecting the preceding frame.

In some examples, the in-deterministic frame 230 may be identified as the intra-BSS frame if the BSSID or BSS color or an address field matches of the preceding frame 215 is associated with the intra-BSS frame and the in-deterministic frame 230 was subsequently received within the threshold period of time of the preceding frame (e.g., SIFS), and/or the address field matches one of the address fields of the preceding frame. Similarly, the in-deterministic frame 230 may be identified as the inter-BSS frame if the BSSID or BSS color or an address field of the preceding frame 215 is associated with the inter-BSS frame and the in-deterministic frame 230 was subsequently received within the threshold period of time of the preceding frame (e.g., SIFS) and/or the address field matches one of the address fields of the preceding frame. Even further, the CTS frame 230 (e.g., in-deterministic frame) may be identified as the inter-BSS frame if the BSSID of the preceding frame is associated with OBSS frame or if the frame was not received within the threshold period of time, or if the preceding frame did not have any of its address fields match with the BSSID of the STA. In the illustrated example, the BSS color information of the preceding frame 215 may correspond to the OBSS frame, the STA 115-a may be able to identify the detected CTS frame 230 as a OBSS frame so long as the CTS frame 230 was received within the threshold period of time 225.

In accordance with the first technique of the present disclosure, the STA 115-a, upon receiving an in-deterministic frame 230 (regardless of whether it is from OBSS device 205 or BSS device (e.g., AP 105-a or STA2 115-b)), may set the inter-BSS NAV 220-b. This is illustrated in FIG. 2B, where in response to receiving an inter-deterministic frame 230 from a BSS device 210, the STA 115-a nonetheless sets the inter-BSS NAV 220 (instead of intra-BSS NAV). In contrast, a frame that includes BSS color information (e.g., RTS frame 215) or a frame that has address field(s) that is that may be associated with BSS device 210 may trigger the STA 115-a to set the intra-BSS NAV 245.

Returning to the example of FIG. 2A, in some examples, during the time period that the inter-BSS NAV 220-b is set, a trigger frame 235 may be received at the STA 115-a from an AP 105-a associated with the STA 115-a. In such situations, the STA 115-a may determine if the inter-BSS NAV 220-b was previously set based on an in-deterministic frame 230. If, the inter-BSS NAV 220-b was set based on the in-deterministic frame 230, the STA 115-a may be configured to respond 240 to a trigger frame 235 from an AP 105-a after the inter-BSS NAV has been set as though the inter-BSS NAV is intra-BSS NAV. In other words, the STA 115-a may be configured to transmit, in response to receiving the trigger frame 235 and before the inter-BSS NAV 220-b is reset, a response 240 to the trigger frame 235 by operating the inter-BSS NAV as an intra-BSS NAV associated with intra-BSS transmissions.

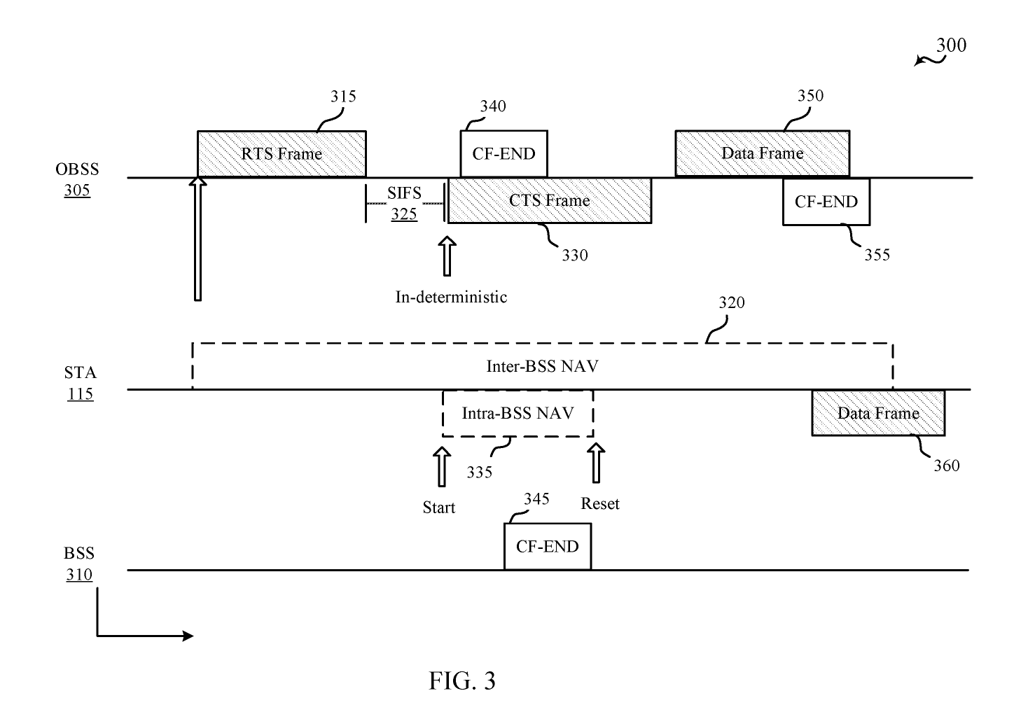

FIG. 3 is another timing diagram 300 of another example of techniques for improving spatial reuse in accordance with aspects of the present disclosure. In accordance with FIG. 3, STA 115-a may be configured to set the inter-BSS NAV 320 in response to receiving frames that include BSS color information (e.g., RTS frame 315) if the RTS frame 315 is received from an OBSS device 305 (e.g., STA3 115-c in FIG. 1). In contrast, if the RTS frame 315 was received from a BSS device 210, the STA 115-a may be configured to set the intra-BSS NAV 335 based on the decoding of the packet.

In contrast to the conventional systems, aspects of the present disclosure provide setting the intra-BSS NAV 335 in response to receiving an in-deterministic frame 330, regardless of whether the in-deterministic frame 330 is received from an OBSS device 305 or BSS device 310. In accordance with further aspects of the second technique, the STA 115-a may reset the intra-BSS NAV 335 in response to the CF-END message 345 being from a BSS device 310 (e.g., based on decoding of an intra-BSS frame). Additionally or alternatively, the STA 115-a may reset the inter-BSS NAV 320 in response to the CF-END message 355 being from an OBSS device 305 (e.g., based on decoding of the inter-BSS frame). As such, in some examples, the STA 115-a may be configured to transmit data 360 on the wireless channel once the inter-BSS NAV 320 and the intra-BSS NAV 335 have been reset in response to their respective CF-END messages.

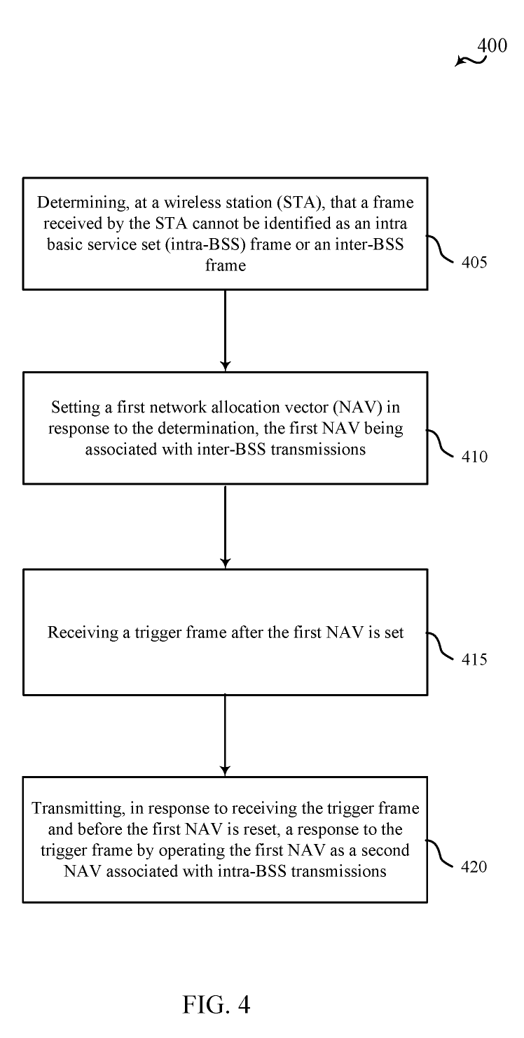

FIG. 4 is a flowchart conceptually illustrating one example of a method 400 of wireless communication, in accordance with aspects of the present disclosure. For clarity, the method 400 is described below with reference to STA 115 FIG. 1.

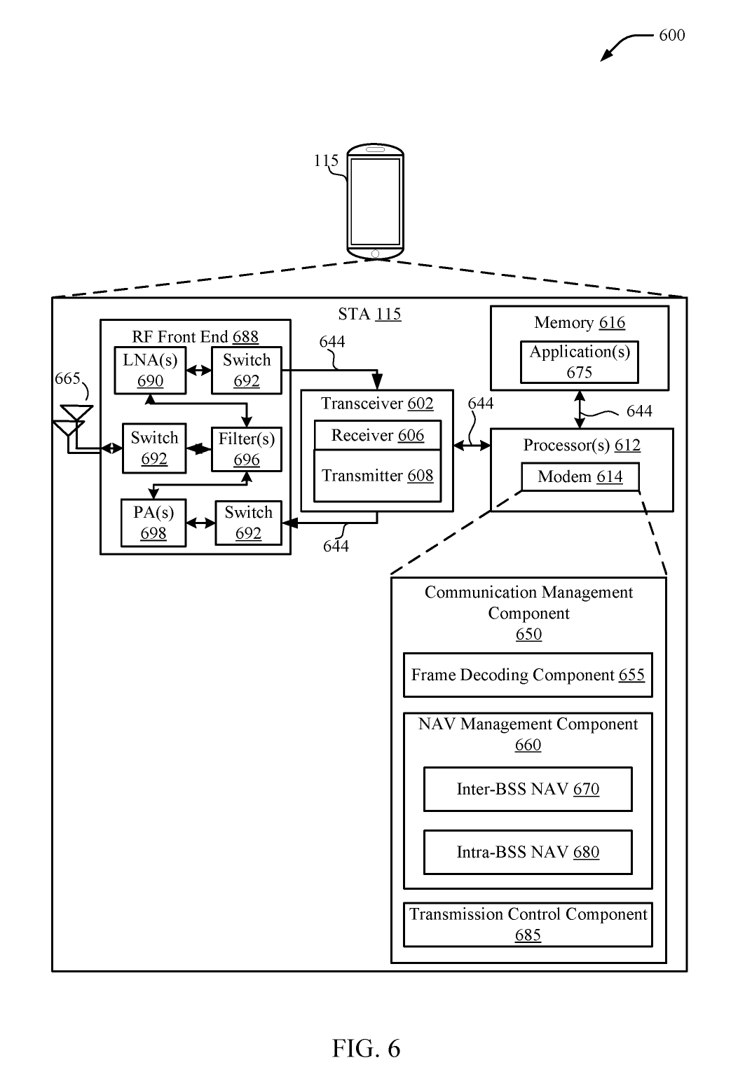

At block 405, the method 400 may include determining, at a STA, that a frame received by the STA cannot be identified as an intra-BSS frame or an inter-BSS frame. In some examples, the method may further include determining whether the frame is received at the STA within a threshold period of time since detecting a preceding frame that included BSSID(s) used by the AP in one of the address field and identifying the frame as the intra-BSS frame or the inter-BSS frame based on determining whether the frame is received with the threshold period of time since detecting the preceding frame, or has address field matching to one of the address field of the preceding frame. The frame may be identified as the intra-BSS frame if the BSSID of the preceding frame is associated with the BSS of the STA, or the frame has the address field that matches one or more of the address fields of the previous frame that was received and that has one of the address field matching the BSSID(s) used by the AP, and the frame was received within the threshold period of time. Alternatively, the frame may be identified as the inter-BSS frame if the BSSID of the preceding frame or any of the address field of the previous frame do not match the BSSID(s) used by the AP of the STA or the frame was not received within the threshold period of time. In some examples, the frame may be one of a CTS or ACK frame that does not include a BSSID. Aspects of 405 may be performed by frame decoding component 655 described in more detail below with reference to FIG. 6.

At block 410, the method 400 may include setting a first NAV in response to the determination. In some examples, the first NAV may be associated with inter-BSS transmissions. Aspects of block 410 may be performed by NAV management component 660 described in more detail below with reference to FIG. 6.

At block 415, the method may include receiving a trigger after the first NAV is set. In some examples, an AP associated with the STA 115 may transmit the trigger frame. In one or more examples, the trigger frame may include identifications of allocated resources (e.g., time slots and frequency) that STA 115 may use to respond to the trigger frame. Aspects of block 415 may be performed by transceiver 602, and more specifically the receiver 606 described in more detail below with respect to FIG. 6.

At block 420, the method may include transmitting, in response to receiving the trigger frame and before the first NAV is reset, a response to the trigger frame by operating the first NAV as a second NAV associated with intra-BSS transmissions. In some examples, the method may include transmitting the response using resources allocated to the STA by an AP in the trigger frame. Aspects of block 420 may be performed by transmission control component 685 described in more detail below with reference to FIG. 6.

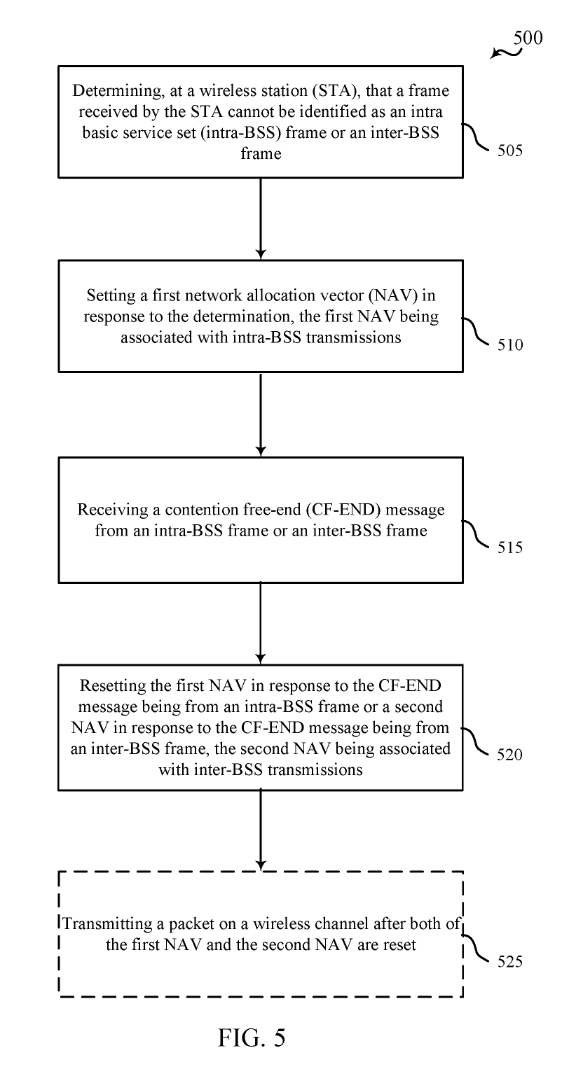

FIG. 5 is a flowchart conceptually illustrating another example of a method 500 of wireless communication, in accordance with aspects of the present disclosure. For clarity, the method 500 is described below with reference to STA 115 of FIG. 1.

At block 505, the method 500 may include determining, at a STA, that a frame received by the STA cannot be identified as an intra-BSS frame or an inter-BSS frame. In some aspects, determining that the frame received by the STA cannot be identified as the intra-BSS frame or the inter-BSS frame comprises failing to identify whether the frame was transmitted by an access point (AP) of same BSS or a different BSS as the STA. In some examples, the method may further include determining whether the frame is received at the STA within a threshold period of time since detecting a preceding frame that included BSSID(s) of the AP of the STA in one or more address fields and identifying the frame as the intra-BSS frame, or the inter-BSS frame based on determining whether the frame is received with the threshold period of time since detecting the preceding frame. The frame may be identified as the intra-BSS frame if the BSSID of the preceding frame is associated with the BSS, or the address fields of the preceding frame match any of the BSSID(s) used by the AP of the STA, and the frame was received within the threshold period of time (e.g., pre-determined inter frame spacing such as SIFS). Alternatively, the frame may be identified as the inter-BSS frame if the BSSID of the preceding frame is associated with OBSS frame, or none of the address fields of the preceding frame do not match the BSSID(s) used by the AP or the frame was not received within the threshold period of time. In some examples, the frame may be one of a CTS or ACK frame that does not include a BSSID. Additionally or alternatively, the frame received at the STA may include a BSSIDs associated with a plurality of APs. Aspects of 505 may be performed by frame decoding component 655 described with reference to FIG. 6.

At block 510, the method 500 may include setting a first NAV in response to the determination. In some examples, the first NAV may be associated with intra-BSS transmissions. Aspects of block 510 may be performed by NAV management component 660 described with reference to FIG. 6.

At block 515, the method may include receiving a CF-END message from an intra-BSS frame or an inter-BSS frame. Aspects of block 515 may be performed by transceiver 602, and more specifically the receiver 606 with respect to FIG. 6.

At block 520, the method may include resetting the first NAV in response to the CF-END message being from an intra-BSS frame or a second NAV in response to the CF-END message being from an inter-BSS frame. In one or more examples, the second NAV may be associated with inter-BSS transmissions. Aspects of block 520 may also be performed by NAV management component 660 described with reference to FIG. 6.

At block 525, the method may include transmitting a packet on a wireless channel after both of the first NAV and the second NAV are reset. In some examples, the method may include transmitting the response using resources allocated to the STA by an AP in the trigger frame. Aspects of block 525 may be performed by transmission control component 685 in conjunction with the transceiver 602 described with reference to FIG. 6.

FIG. 6 describes hardware components and subcomponents of the STA 115 for implementing one or more methods (e.g., methods 400 and 500) described herein in accordance with various aspects of the present disclosure. For example, one example of an implementation of STA 115 may include a variety of components, some of which have already been described above, but including components such as one or more processors 612 and memory 614 and transceiver 602 in communication via one or more buses 644, which may operate in conjunction with communication management component 650 to enable one or more of the functions described herein related to including one or more methods of the present disclosure. Further, the one or more processors 612, modem 614, memory 616, transceiver 602, RF front end 688 and one or more antennas 665, may be configured to support voice and/or data calls (simultaneously or non-simultaneously) in one or more radio access technologies.

In an aspect, the one or more processors 612 can include a modem 614 that uses one or more modem processors. The various functions related to communication management component 650 may be included in modem 614 and/or processors 612 and, in an aspect, can be executed by a single processor, while in other aspects, different ones of the functions may be executed by a combination of two or more different processors. For example, in an aspect, the one or more processors 612 may include any one or any combination of a modem processor, or a baseband processor, or a digital signal processor, or a transmit processor, or a receiver processor, or a transceiver processor associated with transceiver 602. In other aspects, some of the features of the one or more processors 612 and/or modem 614 associated with communication management component 650 may be performed by transceiver 602.

Also, memory 614 may be configured to store data used herein and/or local versions of applications or communication management component 650 and/or one or more of its subcomponents being executed by at least one processor 612. Memory 616 can include any type of computer-readable medium usable by a computer or at least one processor 612, such as random access memory (RAM), read only memory (ROM), tapes, magnetic discs, optical discs, volatile memory, non-volatile memory, and any combination thereof. In an aspect, for example, memory 616 may be a non-transitory computer-readable storage medium that stores one or more computer-executable codes defining communication management component 650 and/or one or more of its subcomponents, and/or data associated therewith, when STA 115 is operating at least one processor 612 to execute communication management component 650 and/or one or more of its subcomponents.

Transceiver 602 may include at least one receiver 606 and at least one transmitter 608. Receiver 606 may include hardware, firmware, and/or software code executable by a processor for receiving data, the code comprising instructions and being stored in a memory (e.g., computer-readable medium). Receiver 608 may be, for example, a radio frequency (RF) receiver. In an aspect, receiver 606 may receive signals transmitted by at least one AP 105. Additionally, receiver 606 may process such received signals, and also may obtain measurements of the signals, such as, but not limited to, Ec/Io, SNR, RSRP, RSSI, etc. Transmitter 608 may include hardware, firmware, and/or software code executable by a processor for transmitting data, the code comprising instructions and being stored in a memory (e.g., computer-readable medium). A suitable example of transmitter 602 may including, but is not limited to, an RF transmitter.

Moreover, in an aspect, STA 115 may include RF front end 688, which may operate in communication with one or more antennas 665 and transceiver 602 for receiving and transmitting radio transmissions, for example, wireless communications transmitted by at least one base station 105 or wireless transmissions transmitted by STA 115. RF front end 688 may be connected to one or more antennas 665 and can include one or more low-noise amplifiers (LNAs) 690, one or more switches 692, one or more power amplifiers (PAs) 698, and one or more filters 696 for transmitting and receiving RF signals.

In an aspect, LNA 690 can amplify a received signal at a desired output level. In an aspect, each LNA 690 may have a specified minimum and maximum gain values. In an aspect, RF front end 688 may use one or more switches 692 to select a particular LNA 690 and its specified gain value based on a desired gain value for a particular application.

Further, for example, one or more PA(s) 698 may be used by RF front end 688 to amplify a signal for an RF output at a desired output power level. In an aspect, each PA 698 may have specified minimum and maximum gain values. In an aspect, RF front end 688 may use one or more switches 692 to select a particular PA 698 and its specified gain value based on a desired gain value for a particular application.

Also, for example, one or more filters 696 can be used by RF front end 688 to filter a received signal to obtain an input RF signal. Similarly, in an aspect, for example, a respective filter 696 can be used to filter an output from a respective PA 698 to produce an output signal for transmission. In an aspect, each filter 696 can be connected to a specific LNA 690 and/or PA 698. In an aspect, RF front end 688 can use one or more switches 692 to select a transmit or receive path using a specified filter 696, LNA 690, and/or PA 698, based on a configuration as specified by transceiver 602 and/or processor 612.

As such, transceiver 612 may be configured to transmit and receive wireless signals through one or more antennas 665 via RF front end 688. In an aspect, transceiver may be tuned to operate at specified frequencies such that STA 115 can communicate with, for example, one or more AP 105 or one or more cells associated with one or more AP 105. In an aspect, for example, modem 614 can configure transceiver 602 to operate at a specified frequency and power level based on the UE configuration of the STA 115 and the communication protocol used by modem 614.

In an aspect, modem 614 can be a multiband-multimode modem, which can process digital data and communicate with transceiver 602 such that the digital data is sent and received using transceiver 602. In an aspect, modem 614 can be multiband and be configured to support multiple frequency bands for a specific communications protocol. In an aspect, modem 614 can be multimode and be configured to support multiple operating networks and communications protocols. In an aspect, modem 614 can control one or more components of STA 115 (e.g., RF front end 688, transceiver 602) to enable transmission and/or reception of signals from the network based on a specified modem configuration. In an aspect, the modem configuration can be based on the mode of the modem and the frequency band in use. In another aspect, the modem configuration can be based on UE configuration information associated with STA 115 as provided by the network during cell selection and/or cell reselection.

The communication management component 650 may include a frame decoding component 655 for identifying in-deterministic frames. In some examples, aspects of the frame decoding component 655 may be responsible for attempting to infer whether the in-deterministic frame is an intra-BSS frame or an inter-BSS frame based on the characteristics of a frame or signal detected preceding the receipt of the in-deterministic frame. In some examples, the frame decoding component 655 may determine whether the frame is received at the STA within a threshold period of time (e.g., within SIFS period) since detecting a preceding frame (e.g., RTS frame or Data frame) that included BSS identification(s) (BSSID) used by the AP in one of the address fields. As such, in some aspects, the frame decoding component 655 may be configured to identify the frame as the intra-BSS frame or the inter-BSS frame based on determining whether the frame is received with the threshold period of time since detecting the preceding frame. Particularly, the frame decoding component 655 determines whether the in-deterministic frame is associated with any preceding frame (e.g., CTS message in response to previously sent RTS or an ACK message in response to a data frame that was transmitted).

In some examples, the in-deterministic frame may be identified as the intra-BSS frame if the BSSID of the preceding frame (e.g., by having decoded at least a portion of the preceding frame—RTS or data frame) is associated with the BSS of the STA, or an address field matches the BSSID(s) used by the AP of the STA, and the in-deterministic frame was subsequently received within the threshold period of time of the preceding frame (e.g., SIFS). In contrast, the frame decoding component 655 may identify the frame (e.g., in-deterministic frame) as the inter-BSS frame if the BSSID of the preceding frame or any of the address field of the preceding frame is not associated with the BSSID(s) used by the AP of the STA, or if the frame was not received within the threshold period of time. The communication management component 650 may also include NAV management component 660 that sets inter-BSS NAV 670 and/or intra-BSS NAV 680 based on receiving one or more frames. In some aspects, the communication management component 650 may further include transmission control component 685 for transmitting packets on the wireless channel when both the inter-BSS NAV 670 and the intra-BSS NAV 680 counters are zero. The transmission control component 685 may further transmit, in response to receiving the trigger frame and before the inter-BSS NAV is reset, a response to the trigger frame by operating the inter-BSS NAV as an intra-BSS NAV associated with intra-BSS transmissions.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A method for wireless communication, comprising:
determining, at a wireless station (STA), that a frame received by the STA cannot be identified as an intra basic service set (intra-BSS) frame or an inter-BSS frame;
setting a first network allocation vector (NAV) in response to the determination, the first NAV being associated with intra-BSS transmissions;
receiving a contention free-end (CF-END) message from an intra-BSS frame or an inter-BSS frame; and
resetting the first NAV in response to the CF-END message being from an intra-BSS frame or a second NAV in response to the CF-END message being from an inter-BSS frame, the second NAV being associated with inter-BSS transmissions.

2. The method of claim 1, further comprising:
determining whether the frame is received at the STA within a threshold period of time since detecting a preceding frame that included BSS identification (BSSID);
identifying the frame as the intra-BSS frame or the inter-BSS frame based on determining whether the frame is received with the threshold period of time since detecting the preceding frame.

3. The method of claim 2, wherein the frame is identified as the intra-BSS frame if the BSSID of the preceding frame is associated with the BSS of the STA and the frame was received within the threshold period of time.

4. The method of claim 2, wherein the frame is identified as the inter-BSS frame if the BSSID of the preceding frame is not associated with the BSS of the STA and the frame was not received within the threshold period of time.

5. The method of claim 1, further comprising:
determining that a preceding frame received prior to the frame, that is in-deterministic, included an address field that matches one of a plurality of BSS identifications (BSSIDs) associated with an access point (AP); and
identifying the frame as the intra-BSS frame or the inter-BSS frame based on determining.

6. The method of claim 1, wherein the frame is one of a clear to send (CTS) frame or an acknowledgment (ACK) frame that does not include a BSS identification (BSSID).

7. The method of claim 1, further comprising:
receiving a trigger frame after the first NAV is set; and
transmitting, in response to receiving the trigger frame and before the first NAV is reset, a response to the trigger frame by operating the first NAV as the second NAV associated with intra-BSS transmissions using resources allocated to the STA by an AP in the trigger frame.

8. The method of claim 1, wherein the frame received at the STA includes a plurality of BSS identifications (BSSIDs) associated with an access point (AP).

9. The method of claim 1, wherein determining that the frame received by the STA cannot be identified as the intra-BSS frame or the inter-BSS frame comprises failing to identify whether the frame was transmitted by an access point (AP) of same BSS or a different BSS as the STA.

10. An apparatus for wireless communication, comprising:
a processor;
a memory coupled to the processor, wherein the memory includes instructions executable by the processor to:
determine, at a wireless station (STA), that a frame received by the STA cannot be identified as an intra basic service set (intra-BSS) frame or an inter-BSS frame;
set a first network allocation vector (NAV) in response to the determination, the first NAV being associated with intra-BSS transmissions;
receive a contention free-end (CF-END) message from an intra-BSS frame or an inter-BSS frame; and
reset the first NAV in response to the CF-END message being from an intra-BSS frame or a second NAV in response to the CF-END message being from an inter-BSS frame, the second NAV being associated with inter-BSS transmissions.

11. The apparatus of claim 10, wherein the instructions are further executable by the processor to:
determine whether the frame is received at the STA within a threshold period of time since detecting a preceding frame that included BSS identification (BSSID);
identify the frame as the intra-BSS frame or the inter-BSS frame based on determining whether the frame is received with the threshold period of time since detecting the preceding frame.

12. The apparatus of claim 11, wherein the frame is identified as the intra-BSS frame if the BSSID of the preceding frame is associated with the BSS of the STA and the frame was received within the threshold period of time.

13. The apparatus of claim 11, wherein the frame is identified as the inter-BSS frame if the BSSID of the preceding frame is not associated with the BSS of the STA and the frame was not received within the threshold period of time.

14. The apparatus of claim 10, wherein the instructions are further executable by the processor to:
determine that a preceding frame received prior to the frame, that is in-deterministic, included an address field that matches one of a plurality of BSS identifications (BSSIDs) associated with an access point (AP); and
identify the frame as the intra-BSS frame or the inter-BSS frame based on determining.

15. The apparatus of claim 10, wherein the frame is one of a clear to send (CTS) frame or an acknowledgment (ACK) frame that does not include a BSS identification (BSSID).

16. The apparatus of claim 10, wherein the instructions are further executable by the processor to:
receive a trigger frame after the first NAV is set; and
transmit, in response to receiving the trigger frame and before the first NAV is reset, a response to the trigger frame by operating the first NAV as the second NAV associated with intra-BSS transmissions using resources allocated to the STA by an AP in the trigger frame.

17. The apparatus of claim 10, wherein the frame received at the STA includes a plurality of BSS identifications (BSSIDs) associated with an access point (AP).

18. A non-transitory computer-readable medium storing computer executable code for wireless communications, comprising code to:
determine, at a wireless station (STA), that a frame received by the STA cannot be identified as an intra basic service set (intra-BSS) frame or an inter-BSS frame;
set a first network allocation vector (NAV) in response to the determination, the first NAV being associated with intra-BSS transmissions;
receive a contention free-end (CF-END) message from an intra-BSS frame or an inter-BSS frame; and
reset the first NAV in response to the CF-END message being from an intra-BSS frame or a second NAV in response to the CF-END message being from an inter-BSS frame, the second NAV being associated with inter-BSS transmissions.

19. The computer-readable medium of claim 18, further comprising code to:
determine whether the frame is received at the STA within a threshold period of time since detecting a preceding frame that included BSS identification (BSSID);
identify the frame as the intra-BSS frame or the inter-BSS frame based on determining whether the frame is received with the threshold period of time since detecting the preceding frame.

20. The computer-readable medium of claim 19, wherein the frame is identified as the intra-BSS frame if the BSSID of the preceding frame is associated with the BSS of the STA and the frame was received within the threshold period of time.

21. The computer-readable medium of claim 19, wherein the frame is identified as the inter-BSS frame if the BSSID of the preceding frame is not associated with the BSS of the STA and the frame was not received within the threshold period of time.

22. The computer-readable medium of claim 18, further comprising code to:
determine that a preceding frame received prior to the frame, that is in-deterministic, included an address field that matches one of a plurality of BSS identifications (BSSIDs) associated with an access point (AP); and
identify the frame as the intra-BSS frame or the inter-BSS frame based on determining.

23. The computer-readable medium of claim 18, wherein the frame is one of a clear to send (CTS) frame or an acknowledgment (ACK) frame that does not include a BSS identification (BSSID).

24. The computer-readable medium of claim 18, further comprising code to:
receive a trigger frame after the first NAV is set; and
transmit, in response to receiving the trigger frame and before the first NAV is reset, a response to the trigger frame by operating the first NAV as the second NAV associated with intra-BSS transmissions using resources allocated to the STA by an AP in the trigger frame.

25. The computer-readable medium of claim 18, wherein the frame received at the STA includes a plurality of BSS identifications (BSSIDs) associated with an access point (AP).

26. An apparatus for wireless communication, comprising:
means for determining, at a wireless station (STA), that a frame received by the STA cannot be identified as an intra basic service set (intra-BSS) frame or an inter-BSS frame;
means for setting a first network allocation vector (NAV) in response to the determination, the first NAV being associated with intra-BSS transmissions;
means for receiving a contention free-end (CF-END) message from an intra-BSS frame or an inter-BSS frame; and
means for resetting the first NAV in response to the CF-END message being from an intra-BSS frame or a second NAV in response to the CF-END message being from an inter-BSS frame, the second NAV being associated with inter-BSS transmissions.

27. The apparatus of claim 26, further comprising:
means for determining whether the frame is received at the STA within a threshold period of time since detecting a preceding frame that included BSS identification (BSSID);
means for identifying the frame as the intra-BSS frame or the inter-BSS frame based on determining whether the frame is received with the threshold period of time since detecting the preceding frame.

28. The apparatus of claim 27, wherein the frame is identified as the intra-BSS frame if the BSSID of the preceding frame is associated with the BSS of the STA and the frame was received within the threshold period of time.

29. The apparatus of claim 27, wherein the frame is identified as the inter-BSS frame if the BSSID of the preceding frame is not associated with the BSS of the STA and the frame was not received within the threshold period of time.

30. The apparatus of claim 26, further comprising:
means for determining that a preceding frame received prior to the frame, that is in-deterministic, included an address field that matches one of a plurality of BSS identifications (BSSIDs) associated with an access point (AP); and
means for identifying the frame as the intra-BSS frame or the inter-BSS frame based on determining.
